(19) United States
(12) Patent Application Publication
(10) Pub. No.: US 2014/0074872 A1
(43) Pub. Date: Mar. 13, 2014

(54) Managing Workload Optimized Systems using Relational Database Modeling and Triggers

(71) Applicants: Sandip Amin, Austin, TX (US); Rishika Kedia, Austin, TX (US); Anbazhagan Mani, Austin, TX (US); Vasu Vallabhaneni, Austin, TX (US)

(72) Inventors: Sandip Amin, Austin, TX (US); Rishika Kedia, Austin, TX (US); Anbazhagan Mani, Austin, TX (US); Vasu Vallabhaneni, Austin, TX (US)

(73) Assignee: INTERNATIONAL BUSINESS MACHINES CORP., Armonk, NY (US)

(21) Appl. No.: 13/608,041

(22) Filed: Sep. 10, 2012

(51) Int. Cl. G06F 17/30

(52) U.S. Cl. 707/758; 707/E17.045

(57) ABSTRACT

Relational database modeling and triggers are employed and coordinated to maintain and manage tunable parameters and characteristics of a Workload Optimized System. The database model is initialized with pre-defined values as per definition of Workload Optimized Systems, which models the optimal configuration of the workload-optimized system, capturing various performance configurations, security and other related system and software configuration. The values present the optimal values for the entire solution. A daemon is run to monitor for changes in the tunable configuration settings, which also updates the current values of the configuration parameters on the RDBMS. SQL Triggers are implemented on the database to identify cases where corrective actions are required to the configuration parameters.

### CROSS-REFERENCE TO RELATED APPLICATIONS (CLAIMING BENEFIT UNDER 35 U.S.C. 120)

None.

### FEDERALLY SPONSORED RESEARCH AND DEVELOPMENT STATEMENT

None.

### MICROFICHE APPENDIX

Not applicable.

### INCORPORATION BY REFERENCE

None.

### FIELD OF THE INVENTION

The invention generally relates to processes, tools and methods for establishing and maintaining computer systems highly optimized for specifici workloads.

### BACKGROUND OF INVENTION

Workload Optimized Systems (WOS), such as International Business Machine's™ (IBM's) Smart Analytics System™ and Oracle's ExaData™ are highly integrated and optimized computing systems for specific workloads. A workload, in this context, refers to the type of computing application or applications which will be executed and performed by the WOS, such as a banking workload, an airline scheduling workload, a stock trading workload, or a web page serving workload.

WOS systems seek to reduce inefficiencies in each workload which arise from the use of general purpose computing hardware, operating systems and application programs, by applying specific computing hardware, optimized operating systems and deeply integrated application programs. For example, the most common processor used in a personal computer, which may also be used in higher-end blade servers, may not be the optimal computing engine for a particular banking operation. As such, implementing a large enterprise level of the banking application on such a general purpose processor may seem like a good choice at first glance, but the inefficiencies accumulate over hundreds of instances of processors, operating systems, and application programs to create massive extra costs, power consumption, and complexity.

A WOS, on the other hand, seeks to select the best choice of processor, memory architecture, bus structure, operating system components and configuration, and highly optimized applications to “tune” the entire system to the specific workload it will perform. In WOS terminology, we refer to “stacks”, which may be horizontal or vertical. A vertical stack is the set of hardware resources (processor, memory, busses, etc.), through the operating system, up to the applications (databases, web servers, etc.). A horizontal stack is a group of homogenous or heterogeneous computing platforms, for example 20 platforms of one hardware architecture coupled to 10 platforms of another hardware architecture running a variety of operating systems. Optimization in a WOS is applied both to the vertical stacks and the horizontal stacks of computing resources.

At a massive computing system level, one might compare a WOS to general purpose enterprise servers in the same way that, at the processor level, special-purpose processors (digital signal processors, graphics accelerators, encryption/decryption engines, etc.) compare to general purpose processors (ARM, SPARC, RISC, x86, PowerPC, etc.). The primary difference between the comparison present here, however, is that the WOS includes many layers of software such as the drivers, operating systems, middleware, database servers, application programs, etc., whereas the comparison at the processor level is primarily an electronic hardware circuitry comparison.

As such, the key goal of designing a workload optimized computing system is on full stack optimization. This requires optimal configuration of hardware (circuitry, processor, memory architecture, bus structures, DMA methods, etc.), firmware (device drivers, communications protocols, embedded processes, etc.), one or more Operating Systems, middleware and application programs.

### SUMMARY OF EXEMPLARY EMBODIMENTS OF THE INVENTION

Relational database modeling and triggers are employed and coordinated to maintain and manage tunable parameters and characteristics of a Workload Optimized System. The database model is initialized with pre-defined values as per definition of Workload Optimized Systems, which models the optimal configuration of the workload-optimized system, capturing various performance configurations, security and other related system and software configuration. The values present the optimal values for the entire solution. A daemon is run to monitor for changes in the tunable configuration settings, which also updates the current values of the configuration parameters on the RDBMS. SQL Triggers are implemented on the database to identify cases where corrective actions are required to the configuration parameters.

### BRIEF DESCRIPTION OF THE DRAWINGS

The description set forth herein is illustrated by the several drawings.

FIG. 1 sets forth a logical process according to the present invention.

FIGS. 2a-2d illustrate system component interactions according to the present invention.

FIG. 3 provides a generalization of a computing platform such as that suitable for realization of some embodiments of the present invention, and such as those suitable for control by embodiments of the invention.

### DETAILED DESCRIPTION OF EXEMPLARY EMBODIMENT(S) OF THE INVENTION

The inventors of the present and the related invention have recognized problems not yet recognized by those skilled in the relevant arts regarding the design, configuration, implementation and continued optimization of Workload Optimized Systems. Correct functioning of the overall solution requires all the configuration elements across the stack (hardware, firmware, OS and application) to be validated and optimal at all times. Any incorrect or non-optimal settings or configuration anywhere on the stack will result in failure, incorrect functionality, or degraded functionality, thereby negatively affecting performance, security, etc.

Further, these configuration settings do not remain static over time after they are initially established at the time of installation and deployment of the system. Rather, they change over time due to changing system characteristics (e.g. expanding memory, upgrading communications bandwidth, etc.), which induces new scenarios and effects on other dependent components.

For example, Workload Optimized Systems like the aforementioned IBM Smart Analytics™ system, have lot of performance “tunables” and security configuration options that are pre-defined at the solution (workload-specific, workload-optimized) level. Some of the Operating System Device tunables are, for example:

#Device tunables

CDA_NUM_CMD_ELEMS=1024 /* maximum number of outstanding
disk array requests allow at a time */
CDA_LG_TERM_DMA=0x1000000 /* long-term DMA memory
area */
CDA_MAX_XFER_SIZE=0x100000 /* Disk maximum I/O tasks to
be issued */

And, some examples of the input/output (IO) tunables are:

#IO Tunables

| | |
|---|---|
| IOO_J2_MAXPAGEREADAHEAD=512 | /* Java2 maximum number |
| | of pages to read ahead */ |
| IOO_J2_MINPAGEREADAHEAD=32 | /* Java2 minimum number |
| | of pages to Read ahead */ |

Some of the Network communications tunables are:

#Network Tunables

```
NO_SB_MAX=1310720 /* maximum number of socket buffers per
                      socket queue */
NO_RFC1323=1 /* enables the TCP window scaling option */
NO_TCP_SENDSPACE=221184 /* how much data the sending
    application can buffer in the kernel before the application is blocked
    on a TCP send call */
NO_TCP_RECVSPACE=221184 /* space for receiving TCP data */
NO_UDP_SENDSPACE=65536 /* space for sending UDP data */
NO_UDP_RECVSPACE=65536 /* space for receiving UDP data */
NO_IPQMAXLEN=250 /* controls the length of the IP input queue */
```

Any change of these configuration parameters from their optimized values for a particular workload will possibly result in degraded performance of workload optimized system, and may defeat the basic purpose of integrated Workload Optimized Systems. In many cases, the allowed values can be within a range rather than an absolute value, also modifying one configuration parameter also results in modifying other applicable configuration parameters, thereby complicating the impact (and potential degradation) on the WOS.

Hence, the present inventors have recognized that there is a need within Systems Management products, such as IBM Systems Director™ product or similar products, to monitor and manage the configuration of servers, operating systems and hardware devices which constitute stacks in Workload Optimized Systems. IBM Systems Director is systems management tool that is used to monitor and manage servers, operating systems and hardware devices. While the following description will be given according to an exemplary embodiment utilizing the IBM Systems Director™ product for the IBM Smart Analytics System™, it should be understood by those skilled in the relevant arts that the present invention is not limited to these particular embodiment and implementation details.

Embodiments according to the present invention use relational database modeling and triggers to maintain and manage Operating System and software configuration options, values, settings, and choices in a Workload Optimized System. In one embodiment, a plugin is added to IBM Systems Director to manage system configuration, which we will refer to as “System and Software Configuration Manager” (SSCM). A relational database, such as DB2, Apache Derby, etc., is initialized with pre-defined values as per definition of Workload Optimized Systems.

Relational Database Systems (RDBS) are used to model the configuration of the workload optimized system. Tables are designed to capture the various performance configurations, security and other related system and software configuration. A database instance is created with standard pre-defined/threshold values (including ranges) for a particular workload optimized system. The values present the optimal values for the entire solution.

Next, a daemon is run on the Operating System, preferably on the same computing platform where the Systems Director server is running, to monitor for changes in the configuration settings. The daemon will update the current values of the configuration parameters on the RDBMS.

And, Structured Query Language (SQL) Triggers are implemented on the database server to identify cases where corrective actions are required to the configuration parameters. For example, the following trigger is used when no_sb_max (maximum number of socket buffers per socket queue) is not within the predefined range. The SQL trigger can invoke a stored procedure or any other script which can be used to perform corrective action, as such for example:

```
CREATE TRIGGER os.networkconfigcheck
    FOR EACH ROW
    WHEN (os. IOO_J2_MAXPAGEREADAHEAD <512 or >756)
    CALL analyzeandreset(os. IOO_J2_MAXPAGEREADAHEAD);
```

In this example trigger, the network communications configuration is checked by examining each row of the RDBMS records which constitute a model of the workload-optimized system. If, in this example, the maximum number of pages to be read ahead when processing a sequentially accessed file on Enhanced JFS is checked to see if it is out of range (less than 512 or more than 756). If so, a procedure “analyzeandreset” is called on that tunable to implement a corrective action.

Another example of an appropriate SQL Trigger is, when a particular configuration option is changed and it has dependency on other configuration parameters and hence it has to be changed as well, then a stored procedure can calculate the changes required and apply them. Preferably, Systems Director administrators can add their own customer triggers on top of any pre-defined triggers provided with the plugin, in at least one embodiment.

In a more specific example, in an IBM Smart Analytics™ System I/O performance tuning for maximum throughput, the following tunable is set for all the AIX-based IOO_J2_MAXPAGEREADAHEAD=512, which specifies the maximum number of pages to be read ahead when processing a sequentially accessed file on Enhanced JFS): In the RDBMS system performance model (set of records), the allowed range of threshold/optimal values are maintained, as shown in Table 1:

TABLE 1
Initial WOS Tunable Model

| | Optimal/Threshold | Current |
|---|---|---|
| Solution Tunable | Value(s) | Value |
| IOO_J2_MAXPAGEREADAHEAD | 512-756 | 512 |
| IOO_J2_MINPAGEREADAHEAD | 32-64 | 32 |
| Tunable3 | . . . | . . . |
| Tunable4 | . . . | . . . |
| Tunable5 | . . . | . . . |

In this table, the tunable parameter IOO_J2_MAXPAGEREADAHEAD is allowed to be optimally set between 512 and 756, and it is currently set to 512 (within allowable range), and the tunable parameter IOO_J2_MINPAGEREADAHEAD is allowed to be optimally set between 32 and 64, which is currently set to 32.

Now, for the purposes of this example, assume that on server1, an administrator changes the value of tunable IOO_J2_MAXPAGEREADAHEAD from 512 to 1024. The monitoring daemon running on server1(or from other server) will be notified of this change via standard operating system event monitoring mechanisms, and the model in the RDBMS is appropriately updated:

TABLE 2
Updated WOS Tunable Model

| | Optimal/Threshold | Current |
|---|---|---|
| Solution Tunable | Value(s) | Value |
| IOO_J2_MAXPAGEREADAHEAD | 512-756 | 1024 |
| IOO_J2_MINPAGEREADAHEAD | 32-64 | 32 |
| Tunable3 | . . . | . . . |
| Tunable4 | . . . | . . . |
| Tunable5 | . . . | . . . |

Next, an SQL trigger associated with the RDBMS value IOO_J2_MAXPAGEREADAHEAD will cause an appropriate Stored Procedure to evaluate the impacts of this value change. Some example potential impacts which are evaluated in at least one embodiment are:

Solution performance may be lowered

Solution components may crash or die

Solution availability may be reduced

For the purposes of this example, assume that the impact of the change is determined to be reduced performance, such as increased time to process and online transaction (OLTP). Based on the impacts to the solution, stored procedure finds a suitable corrective action. For example, the corrective actions could be:
Reset the tunable to be within the optimal values
Shutdown some parts of the solution
Start other servers or services, and transfer some or all of the load to them

In this particular example, we will presume that the appropriate corrective action is to reset the tunable IOO_J2_MAXPAGEREADAHEAD to a value within its range. It could be set to a value in the center of the range, or because the attempted change was beyond the maximum value of the allowable optimized range, it could be set to the maximum allowable value. Once the corrective action is taken, solution is monitored again for more changes.

If there are more than 1 change to the solution, multiple stored procedure are triggered and placed on a queue. Overall system impact will be impacted only after impact analysis of all the changes is done. This will allow a full impact analysis at system level.

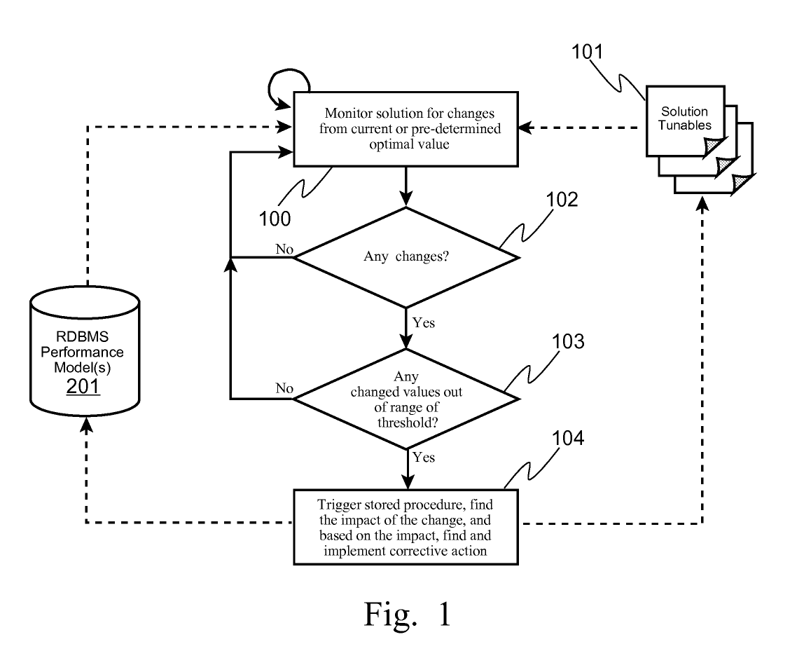

In FIG. 1, a generalized logical process according to the invention and consistent with the previous examples is shown. The logical process monitors (100) the solution (e.g. the WOS) for changes from the current or pre-determined tunable optimal values by comparing the actual tunable values (101) to those stored in the model (201). If any changes are detected (102), then a check is made of the allowable range of value or threshold for the changed values (103). If a value is found to have been changed beyond a threshold or out of the optimal range, then a stored procedure is triggered (104) to resolve the matter, as previously described.

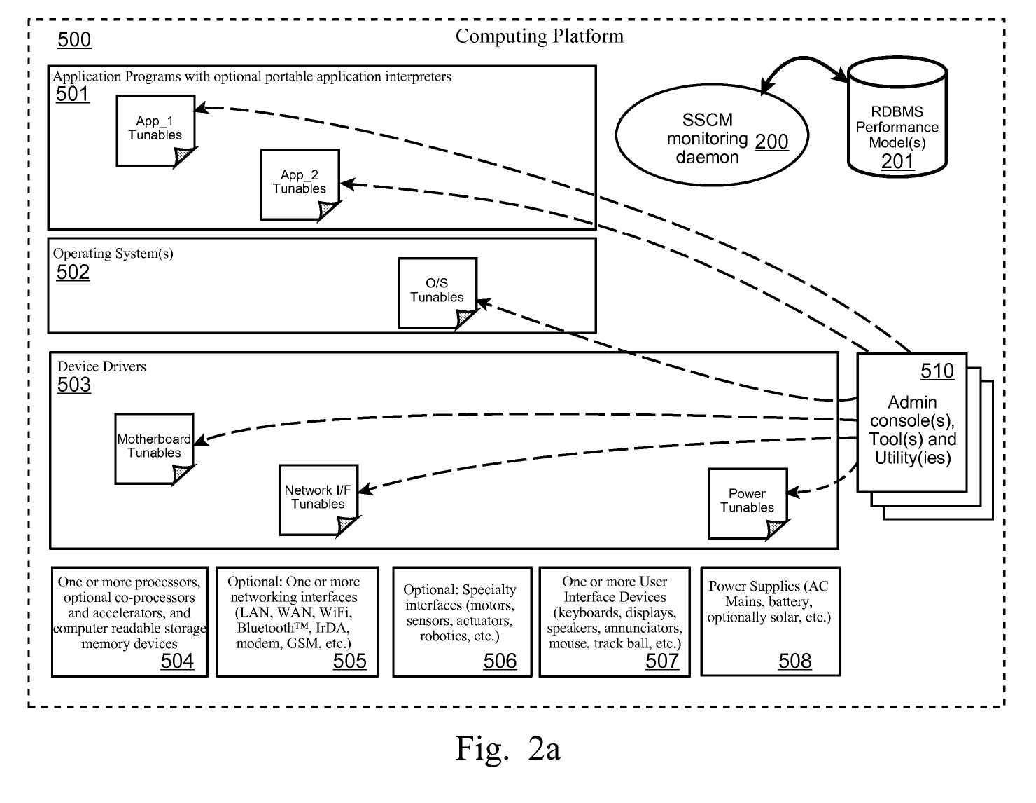

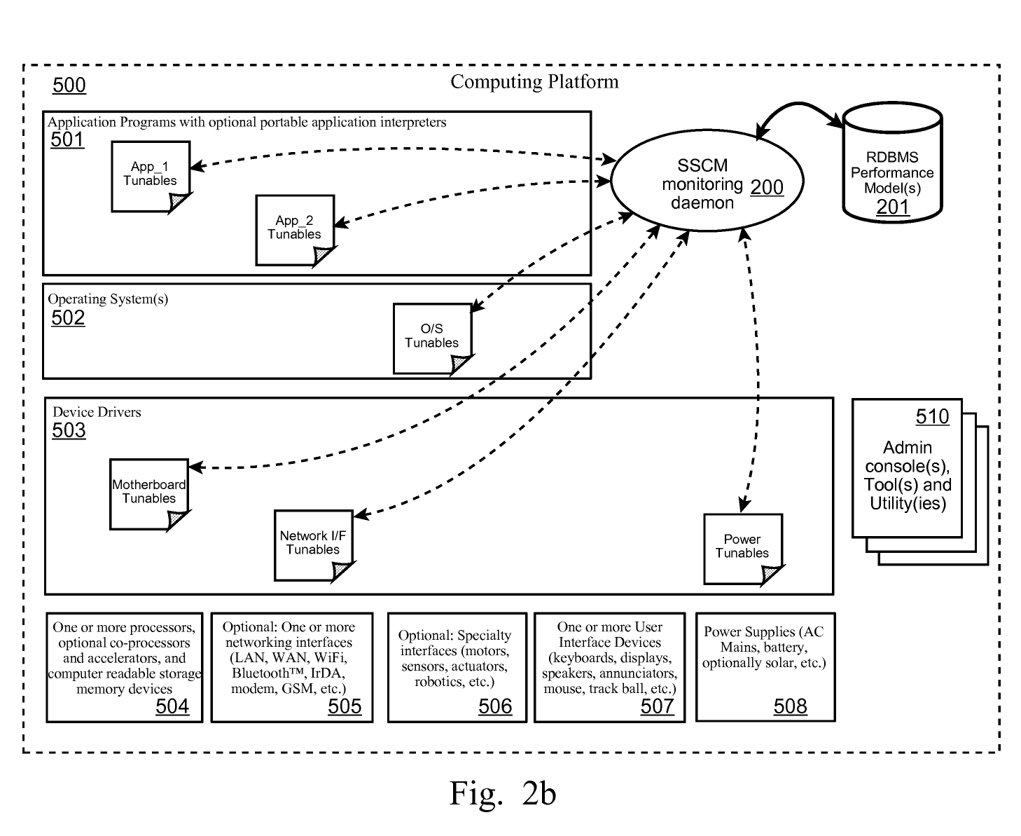

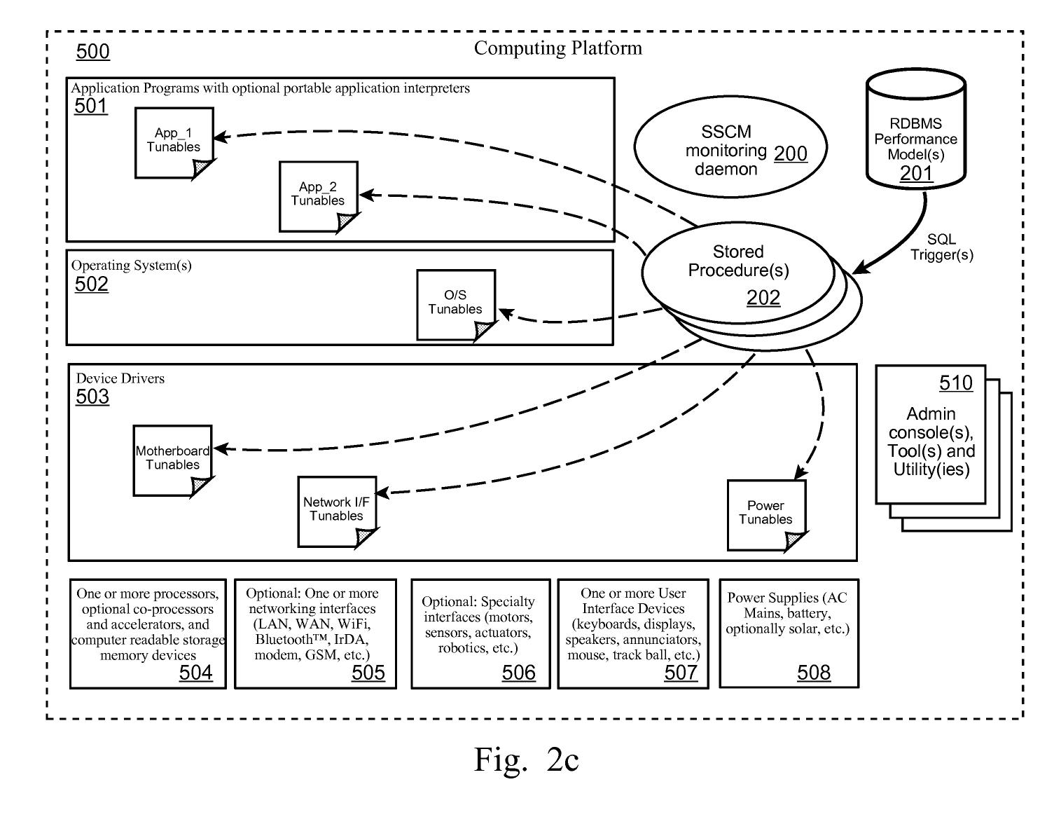

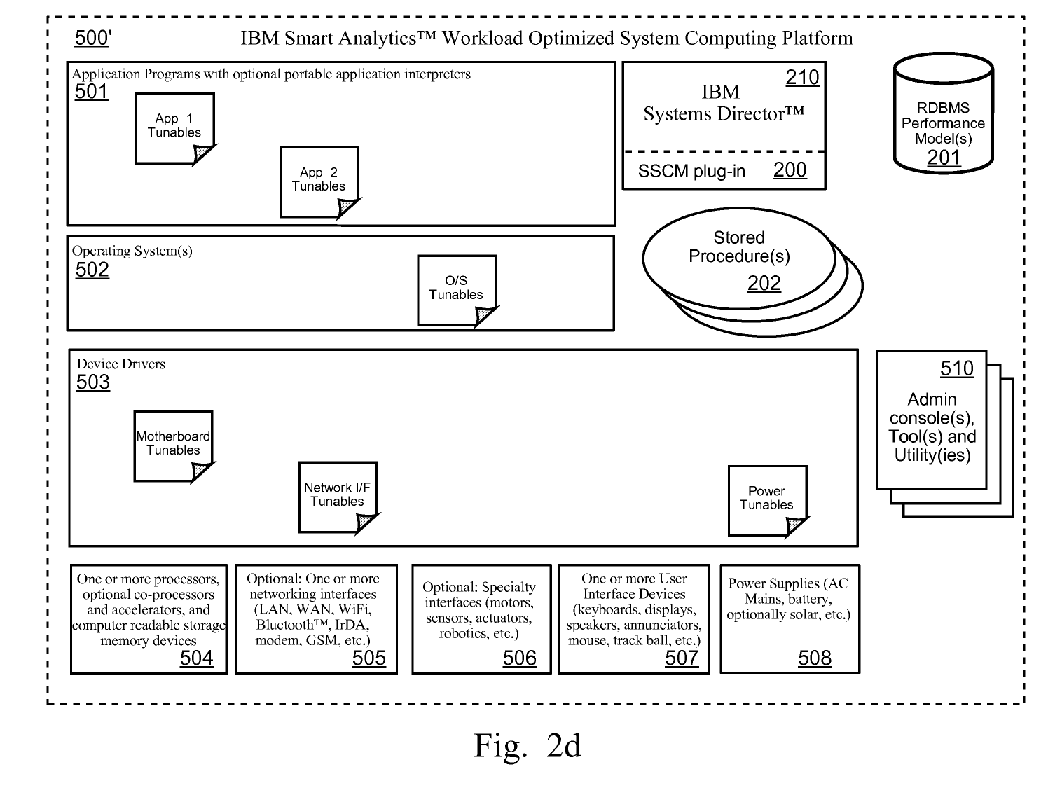

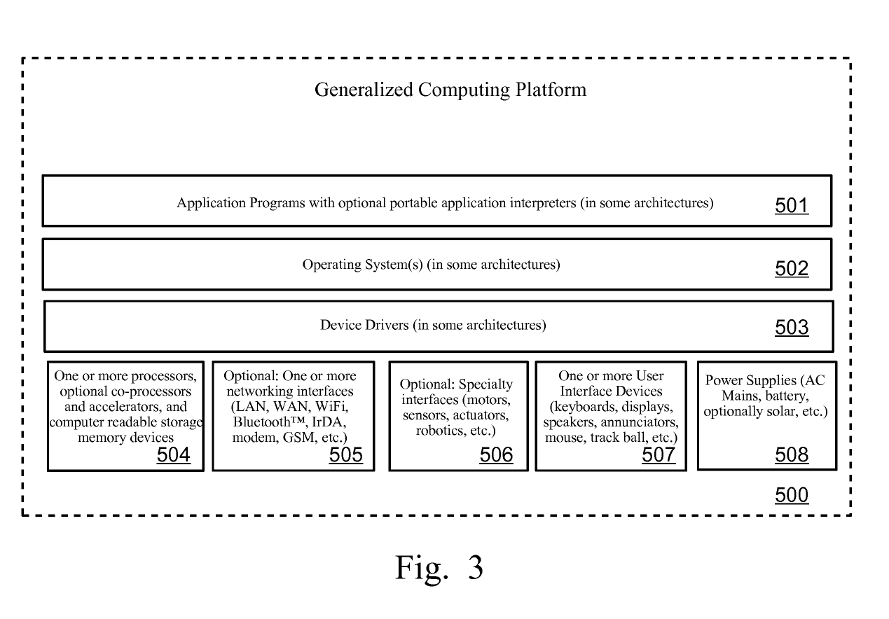

Turning to FIG. 2a, a generalized computing platform (500), which includes a vertical stack of a set of hardware devices (504, 505, 506, 507, 508), device drivers (503), one or more operating systems (502) and one or more application programs (501), all of which, in this scenario, constitute a workload optimized system. One or more administrator consoles, tools and utilities (510) allow an administrator to make changes (shown in dotted line arrows) to tunable parameters and characteristics in each layer of the vertical stack.

Referring now to FIG. 2b, the monitoring daemon (200) according to at least one embodiment of the present invention accesses the tunables, and compares their current state to the records (model) of their previous values (or initial values) stored in the RDBMS (201).

Upon detection of a change in a tunable value, and as shown in FIG. 2c, an SQL trigger from the RDBMS (201) will activate and execute one or more stored procedures (202) to resolve, and if necessary correct the change to restore it to an optimal value, thereby maintaining optimization of the computing system for the particular workload and/or applications.

FIG. 2d shows an embodiment in which the monitoring daemon (200) is incorporated into an IBM Smart Analytics™ system as a plug-in to the IBM Systems Director (210).

Suitable Computing Platform.

The preceding paragraphs have set forth example logical processes according to the present invention, which, when coupled with processing hardware, embody systems according to the present invention, and which, when coupled with tangible, computer readable memory devices, embody computer program products according to the related invention.

Regarding computers for executing the logical processes set forth herein, it will be readily recognized by those skilled in the art that a variety of computers are suitable and will become suitable as memory, processing, and communications capacities of computers and portable devices increases. In such embodiments, the operative invention includes the combination of the programmable computing platform and the programs together. In other embodiments, some or all of the logical processes may be committed to dedicated or specialized electronic circuitry, such as Application Specific Integrated Circuits or programmable logic devices.

The present invention may be realized for many different processors used in many different computing platforms. FIG. 5 illustrates a generalized computing platform (500), such as common and well-known computing platforms such as “Personal Computers”, web servers such as an IBM iSeries™ server, and portable devices such as personal digital assistants and smart phones, running a popular operating systems (502) such as Microsoft™ Windows™ or IBM™ AIX™, Palm OS™, Microsoft Windows Mobile™, UNIX, LINUX, Google Android™, Apple iPhone iOS™, and others, may be employed to execute one or more application programs to accomplish the computerized methods described herein. Whereas these computing platforms and operating systems are well known an openly described in any number of textbooks, websites, and public “open” specifications and recommendations, diagrams and further details of these computing systems in general (without the customized logical processes of the present invention) are readily available to those ordinarily skilled in the art.

Many such computing platforms, but not all, allow for the addition of or installation of application programs (501) which provide specific logical functionality and which allow the computing platform to be specialized in certain manners to perform certain jobs, thus rendering the computing platform into a specialized machine. In some “closed” architectures, this functionality is provided by the manufacturer and may not be modifiable by the end-user.

The “hardware” portion of a computing platform typically includes one or more processors (504) accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces (505) may be provided, as well as specialty interfaces for specific applications. If the computing platform is intended to interact with human users, it is provided with one or more user interface devices (507), such as display(s), keyboards, pointing devices, speakers, etc. And, each computing platform requires one or more power supplies (battery, AC mains, solar, etc.).

Conclusion. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It should also be recognized by those skilled in the art that certain embodiments utilizing a microprocessor executing a logical process may also be realized through customized electronic circuitry performing the same logical process(es).

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

1. A method for managing tunable characteristics of Workload Optimized Systems comprising:
monitoring by a computer system a plurality of tunable parameters of a workload optimized computing system;
detecting by a computer system a difference in a monitored tunable parameter and a corresponding parameter value in an optimized vertical stack model, wherein the vertical stack model comprises at least a real hardware layer, a real operating system layer, and a real application later;
responsive to detecting a difference, comparing by a computer system the monitored value to at least one threshold for the tunable parameter according to an optimized model for the vertical stack; and
responsive to the monitored value being beyond the threshold triggering by a computer system a stored procedure to initiate a corrective action to set the monitored tunable parameter to be compliant with the threshold.

2. The method as set forth in claim 1 wherein the monitoring is performed at least in part by a plug-in to a systems management tool.

3. The method as set forth in claim 1 wherein the model comprises a set of records stored in a database.

4. The method as set forth in claim 3 wherein the database comprises a Relational Database Management System.

5. The method as set forth in claim 1 wherein the triggering comprises a query language trigger.

6. The method as set forth in claim 5 wherein the query language comprises Structured Query Language.

7. The method as set forth in claim 1 wherein the detecting comprises predicting one or more impacts selected from the group consisting of system performance may be lowered due to the changed value, a system component may be damaged due to the changed value, a system component may malfunction due to the changed value, and system availability may be reduced due to the changed value.

8. The method as set forth in claim 1 wherein the corrective action comprises one or more actions selected from the group consisting of resetting the tunable parameter to be within a range of values, resetting the tunable parameter to be within a threshold, shutting down a portion of the workload optimized system, starting an additional workload optimized server, and transferring workload to another server.

9. The method as set forth in claim 1 wherein a plurality of corrective actions are triggered responsive to detecting a plurality of changed tunable parameters.

10. A computer program product for managing tunable characteristics of Workload Optimized Systems comprising:
a tangible, computer readable storage memory device excluding a propagating signal;
one or more program instructions encoded by the tangible, computer readable storage memory device for, when executed, causing a processor to perform operations of:
monitoring a plurality of tunable parameters of a workload optimized computing system;
detecting a difference in a monitored tunable parameter and a corresponding parameter value in an optimized vertical stack model, wherein the vertical stack model comprises at least a real hardware layer, a real operating system layer, and a real application later;
responsive to detecting a difference, comparing the monitored value to at least one threshold for the tunable parameter according to an optimized model for the vertical stack; and
responsive to the monitored value being beyond the threshold, triggering a stored procedure to initiate a corrective action to set the monitored tunable parameter to be compliant with the threshold.

11. The computer program product as set forth in claim 10 wherein the model comprises a set of records stored in a database.

12. The computer program product as set forth in claim 11 wherein the database comprises a Relational Database Management System.

13. The computer program product as set forth in claim 10 wherein program instruction for triggering comprises a query language trigger.

14. (canceled)

15. The computer program product as set forth in claim 10 wherein the program code for detecting comprises program code for predicting one or more impacts selected from the group consisting of system performance may be lowered due to the changed value, a system component may be damaged due to the changed value, a system component may malfunction due to the changed value, and system availability may be reduced due to the changed value, and where the corrective action comprises one or more actions selected from the group consisting of resetting the tunable parameter to be within a range of values, resetting the tunable parameter to be within a threshold, shutting down a portion of the workload optimized system, starting an additional workload optimized server, and transferring workload to another server.

16. A system for managing tunable characteristics of Workload Optimized Systems comprising:
a computer system having a processor;
a tangible, computer readable storage memory device; and
one or more program instructions encoded by the tangible, computer readable storage memory device for, when executed, causing a processor to perform operations of:
monitoring a plurality of tunable parameters of a workload optimized computing system;
detecting a difference in a monitored tunable parameter and a corresponding parameter value in an optimized vertical stack model, wherein the vertical stack model comprises at least a real hardware layer, a real operating system layer, and a real application later;
responsive to detecting a difference, comparing the monitored value to at least one threshold for the tunable parameter according to an optimized model for the vertical stack; and
responsive to the monitored value being beyond the threshold, triggering a stored procedure to initiate a corrective action to set the monitored tunable parameter to be compliant with the threshold.

17. The system as set forth in claim 16 wherein the model comprises a set of records stored in a database.

18. The system as set forth in claim 17 wherein the database comprises a Relational Database Management System.

19. The system as set forth in claim 16 wherein program code for triggering comprises a query language trigger.

20. The system as set forth in claim 16 wherein the program instruction for detecting comprises program instruction for predicting one or more impacts selected from the group consisting of system performance may be lowered due to the changed value, a system component may be damaged due to the changed value, a system component may malfunction due to the changed value, and system availability may be reduced due to the changed value, and where the corrective action comprises one or more actions selected from the group consisting of resetting the tunable parameter to be within a range of values, resetting the tunable parameter to be within a threshold, shutting down a portion of the workload optimized system, starting an additional workload optimized server, and transferring workload to another server.
